(19) United States
(12) Patent Application Publication
(10) Pub. No.: US 2013/0218770 A1
(43) Pub. Date: Aug. 22, 2013

(54) System and Method for Performing Financial and Other Transactions with Increased Automation, Improved Security and/or Usage of Data

(71) Applicants: John B. Prather, Las Vegas, NV (US); David M. Weiss, Las Vegas, NV (US)

(72) Inventors: John B. Prather, Las Vegas, NV (US); David M. Weiss, Las Vegas, NV (US)

(21) Appl. No.: 13/645,363

(22) Filed: Oct. 4, 2012

Related U.S. Application Data
(60) Provisional application No. 61/542,904, filed on Oct. 4, 2011.

(51) Int. Cl. G06Q 20/40

(52) U.S. Cl. CPC G06Q 20/40145
USPC 705/44

(57) ABSTRACT

An apparatus, system and method for securely withdrawing, exchanging, depositing and reconciling funds (cash and no-cash value) from automated media item(s) and delivery system for employees, patrons or other individuals so that cash equivalent value can be issued at authorized location, via a tracked and disbursed, exchanged or deposited funds, or other means of printed or credit transfer. Software to integrate various devices and associated databases that are remotely connected to a network, such as the web, including a login device, accounting device, funds delivery device and accounting device.

### CROSS-REFERENCE TO RELATED APPLICATION

This application claims the benefit of U.S. Provisional Application No. 61/542,904, filed Oct. 4, 2011.

### FIELD OF THE INVENTION

The current invention generally relates to systems and methods for performing financial and other transactions with increased automation and/or improved security, including systems that use iris recognition to identify a user. The current invention also generally relates to systems and methods for integrating devices for performing such transactions, including the use of data generated by such systems and methods.

### BACKGROUND OF THE INVENTION

Various industries currently exist where employees handle cash, credit card and other types of financial transactions. For example, employees at hotels, financial institutions, retailers, gaming establishments, restaurants, quick service restaurants, convenience stores and groceries may handle many cash and/or credit card transactions during a given shift. As a specific example, a waitress or bartender at a restaurant or casino will typically collect cash or run credit card transactions during his or her shift. Similarly, employees operating cash registers at retailers will also collect cash and conduct credit card transactions. Such employee-based operations are sometimes referred to as employee banking processes, and the cash and credit card receipts that an employee has on hand is sometimes referred to as an employee bank.

The manual employee banking process normally requires a cashier and/or accountant to process the preparation, delivery, deposit, reconciliation and audit of cash and non-cash value funds. It may also require authorized employees operating in a cash/non-cash media item position or management roles of support to receive, exchange and/or deposit either with the cashier, accountant or secure storage vaults. When the authorized employees conduct their manual processes, all impacted personnel must complete verification of all transactions and track either through paper tracking process or basic manual system spreadsheets for audit purposes. As can be appreciated, employee banking has typically been a labor intensive process which generally increases costs to the company.

As time goes by, companies in the retail and entertainment industries, as well as other industries, continue to evolve and strive to improve the customer experience. Oftentimes, this has involved providing service where employees handle cash and other types of customer financial transactions. This typically requires increased labor and additional cash reserves to support the operations of these companies' services. As companies continue to expand and/or provide more services, they have evaluated and conducted many manual processing applications to receive, account for and disburse cash, conduct other financial transactions and use the data associated with such transactions.

Again using the waitress example, a significant amount of time may be necessary to manually account for the cash and credit card transactions that may occur during the waitress' shift. And at the end of her shift, more time is typically necessary to reconcile the cash and receipts brought in, to disburse the appropriate amount of pay to that employee and/or to receive and input financial information. Besides the increased labor costs of manual operations, security issues may also arise where employees handle financial transactions.

To reduce or otherwise address the time needed to handle such transactions, some companies and operators have implemented automated products as they have become available. These products have included: cash and coin dispensing units to issue cash and coin for employee banks, deposit units to allow employee bank verified cash and coin revenue deposits, cash only recycler units to disburse and deposit employee banks cash only and also storage units that hold pre-prepared secured employee banks which are accessible through employee security card or pin access.

All these products have assisted with reducing some aspects of the overall operational labor and the cash recycler units deployed in these industries. They have also helped reduce the cash reserve requirements that may be necessary at a given time. However, many of these early recycler units and other automated devices were developed prior to the explosive growth of the internet and associated communication protocols. As such, these devices have limited capacities and communication protocols that are unable to support the overall market segment operational capacities at a cost effective level. The following are several examples of attempts at automation but which each have their drawbacks.

1) Cash and Coin dispensing units improve the speed and time to disburse employee banks.

However, these units have only been available with “blind” drop mechanisms such as secured vaults for cash and coin bag deposit of the employee bank and revenue. Furthermore, these cash and coin dispensing units have not offered a more comprehensive solution which negatively impacts the operations in the aspects of: a) no reduction in cash reserve for operations and in some cases increase the cash reserve requirements by requiring stored “swap-out” cassettes for replenishment, b) “blind” drop deposit of employee bank and revenue require employee to complete “bag drop” process which requires time and accuracy on the part of the end-of-shift employee; this process requires additional labor hours for the count team or employees responsible for retrieving the banks to open and verify accurately all employee banks and revenues, c) further time and labor requirements of manually presented documentation to the accounting reconciliation personnel which may not be posted and recognized for accuracy including “over and shorts” of the employee transactional activity up to a period 24 hours or more.

2) Deposit units, which include currency counters with a cassette or a bin modified vault unit to captured deposited employee cash revenues, and which are sometimes accompanied with a coin sorter with secured bag stand, have reduced the operational labor requirements of employee revenue deposit and have simplified the employee revenue turn-in process. This has eliminated the employee cage transaction thereby reducing the employee-to-employee activity for “back of the house” operations for deposit of revenue. This processing unit type also decreases time of reconciliation of the revenue verification by the count team or employees responsible for retrieving the revenue cassette.

However, such deposit units have not offered a more comprehensive solution which negatively impacts the operations in several aspects. For example, (a) there is no reduction in cash reserve for operations; due to lack of disbursement delivery units for employee banks, operators require additional labor for employee bank “turn-ins” at the end-of-shift and to keep employee cage personnel on staff to prepare employee banks and to disburse employee banks to employees; other implemented processes to reduce requirements of employee cage employees include an aged process of preparing and issuing an employee transferred and signed-for employee bank amount that are stored in secured “lockers” or “boxes” which is unverified at the end-of-shift by the property management and that are audited or occasionally “spot checked” by count room or cage employees, requiring additional employee labor verification of employee banks and the exposure to the organization for mismanagement of employees bank amount which may result in employee release from duties if incorrect employee bank amount is discovered during audit or “spot check”. Furthermore, the use of “lockers or “boxes” require all employee banks to be prepared, assigned and available for all shifts of operation requiring more cash reserves than actually required within a particular shift or day of operation based on property daily activities. Also, (b) currency counters utilized for the volume of activity required from employee revenue deposit typically require substantial maintenance and calibration to ensure accurate counts of revenue verification costing valuable down time and potential manual process of employee revenue turn-in to employee cage personnel. Also, (c) cassette capacities of deposit units for employee revenue typically require multiple units to allocate enough storage space to operate effectively in a 24 hour period. If not enough deposit units are utilized, an emergency drop process must be implemented that requires employees to exchange and prepare for end of day verification.

3) Cash only recycling units provide a reduction of cash reserves to operate the distribution and deposit of employee banks and revenue. They also reduce the labor requirements of employee cage for disbursement and deposit of cash along with the reduction of labor of verifying the bank and revenue cash deposits by the count team or assigned employee personnel.

However, these cash only recycling units have not offered a more comprehensive total solution which negatively impacts the operations in several aspects: a) coin disbursement and deposit is required to be conducted manually between employees and requires a verification for accounting separate from the cash only recycling system creating labor requirements for this manual operation and b) cash only recyclers have not been able to deliver acceptable capacity levels to handle the volume of disbursements and deposits of employee banks for large organizations causing increased labor management of the units.

4) Storage units provide the ability to eliminate the disbursement process between employees which reduces the labor time associated with employee-to-employee disbursement operations. However, storage units have not offered a more comprehensive total solution which negatively impacts the operations in the aspects of: a) employee banks must be prepared and entered into the storage unit not reducing the labor of employee bank preparation, b) employee banks and/or revenues must be manually transferred with employee cage personnel, making no change to labor requirements of this process and c) verification and funds accountability remains a manual process to accounting allowing no change in labor requirements.

The overall process of cash reserve and labor management of the disbursement, exchange, deposit and reconciliation process continue to require a product solution to address all areas of operation in order to reach the organizations optimal operating capacity for the operations. Accordingly, there is a need for a further automated system that reduces labor and other costs associated with such systems. To this end, there is a need for a more advanced integration of system components to provide these benefits, such as by using web-based systems. Associated with this is a need for a software system providing such integration.

Beyond the costs associated with the above-described systems, security risks may also arise. For example, a security issue may arise anytime an employee is responsible for accounting, reconciling or other handling of financial transactions, as opposed to an automated process. As another example, certain financial transactions may involve the use of PINs, card swipes or other passwords which may be compromised in a variety of ways. Passwords may also be forgotten resulting in wastes of time. Accordingly, there exists a need for a more secure system that allows employees to perform financial transactions at the end of their shift without the need for user IDs, PINs or other security measures which may be compromised.

### SUMMARY OF THE INVENTION

The system of the current invention addresses the foregoing and other issues. In one aspect of the current invention, a web based integrated system is described which provides increased automation for financial transactions.

In another aspect of the current invention, a web based system is described which provides increased security through the use of, for example, iris recognition to identify an employee and authorize a transaction.

In another aspect of the current invention, software is described which helps provide the above-referenced integration and other data usage functions. The software application preferably provides integration protocols for current and future methodologies in a construction to facilitate system to system communication for the purposes of audit process such as point of sale systems (ex. Micros 9700), to integrate employee reconciliation and the capability of producing payment for tip or due-back payouts for employee tips and to record the total tip payments for audit and reconciliation of external system transactions. The software application provides integrations to audit accounting systems conducting export and import communications through the software application web service providing audit and reconciliation tools. The software application completes web based multi-unit communication for compiling status and accountability of each unit, location, property or organization.

Other aspects and details of the present invention may be more completely understood by reference to the following detailed description of the preferred embodiment taken in connection with the drawings and the appended claims.

### BRIEF DESCRIPTION OF THE DRAWINGS

FIG. 1 is a system diagram showing an embodiment of the current invention.

FIG. 2 is a system diagram showing an embodiment of the current invention.

FIG. 3 is a system diagram showing an embodiment of the current invention.

### DETAILED DESCRIPTION OF THE PREFERRED EMBODIMENTS

Embodiments of the current invention will now be described with reference to the drawings. To facilitate the description, any reference numeral representing an element in one figure will represent the same element in any other figure. The current invention is not limited to the specific description below, as one skilled in the art will appreciate that variations may occur to the subject matter described below while still being within the scope and content of the current invention. The description below makes reference to systems typically referenced as employee banking systems, and also makes reference to the gaming industry, but one skilled in the art will recognize that the current invention is suitable for use with other types of transactions and other types of industries.

The current invention relates to apparatus, systems and methods involving what is sometimes referenced as a Currency Banking Management System (“CBMS”). The CBMS of the current invention preferably provides for the secure withdrawal, exchange, deposit and reconciliation of funds (cash and no-cash value) from automated media item(s). The current invention also relates to a delivery system (cash and no-cash value) for employee or patron funds accounts which enable the cash equivalent value to be issued at an authorized location, via tracked and disbursed, exchanged or deposited funds, or other means of printed or credit transfer. In this manner, the current invention may effectively function as an automated cashier system for a customer at the customer's defined location, for the employee or for the patron to execute a transaction for authorized and desired funds.

The CBMS of the current invention preferably includes a secure Windows/web based system application and banking delivery unit with a user login or access device that provides security for the transaction by identifying the user and authorizing the transaction. In one embodiment, the user login device may include a PC touch screen display where the user, e.g., an employee, enters a user ID and/or encrypted PIN (Personal Identification Number) or other password.

In another embodiment, the login device may include an iris biometric security access reader which authorizes the user to use the CBMS upon matching the user's iris with information stored in a database of iris information for authorized users. In this embodiment, the system may also include a delivery device or system, i.e., a cash and coin dispenser/recycler bill and other media item validators, which allows the user to complete a financial transaction without having to verify transaction manually with a touch screen or with other employee(s) or patron(s).

In another embodiment, a combination of the foregoing may be used, e.g., to provide security for different types of transactions, and or otherwise enhanced security.

The CBMS of the current invention may be an external attachment to the delivery device or embedded in the delivery device. In any event, it is preferred that each delivery device be associated with a specific instance of CBMS with an encrypted unique identifier.

As indicated above, the process of the user accessing the CBMS may occur through PIN entry or iris biometric security access. Upon being granted access, the user may request a specific transaction. The type of transaction that may be accessed may vary according to that user's level or type of access, or other information associated with that particular user. For example, for particular users, the CBMS may dispense a predetermined amount automatically. Alternatively, the user may have access that allows the user to determine the amount of the request within his or her allowable disbursement level.

Upon being granted access, users may also complete other types of transactions, such as exchange transactions to define a specific disbursement configuration based on the amount authorized and deposit for exchange. A deposit transaction may be completed by users providing access credentials, which transaction may also provide cash, coin and other cash and non-cash value media items for deposit to the delivery unit. The CBMS application may preferably track all transactions conducted and provide various reporting functions for the delivery unit, users, accountants and owners.

The current invention also relates to control software applications for the purpose of completing electronic journal tracking and transactions from the delivery unit. For example, the software of the current invention may provide auditing functions. The software may also facilitate a transactional terminal Gateway communication system and method for enabling users to access and manage funds using CBMS and delivery unit.

The system and method of the current invention may also include a local area network (LAN) or wireless fund(s) transfer management devices for use with accounting, audit, finance and operations functions, such as food and beverage (bars, restaurants, hotel front desk, etc. . . . ), and property and/or management operator. These devices may include point of sale (POS) terminals, operator terminals and related systems.

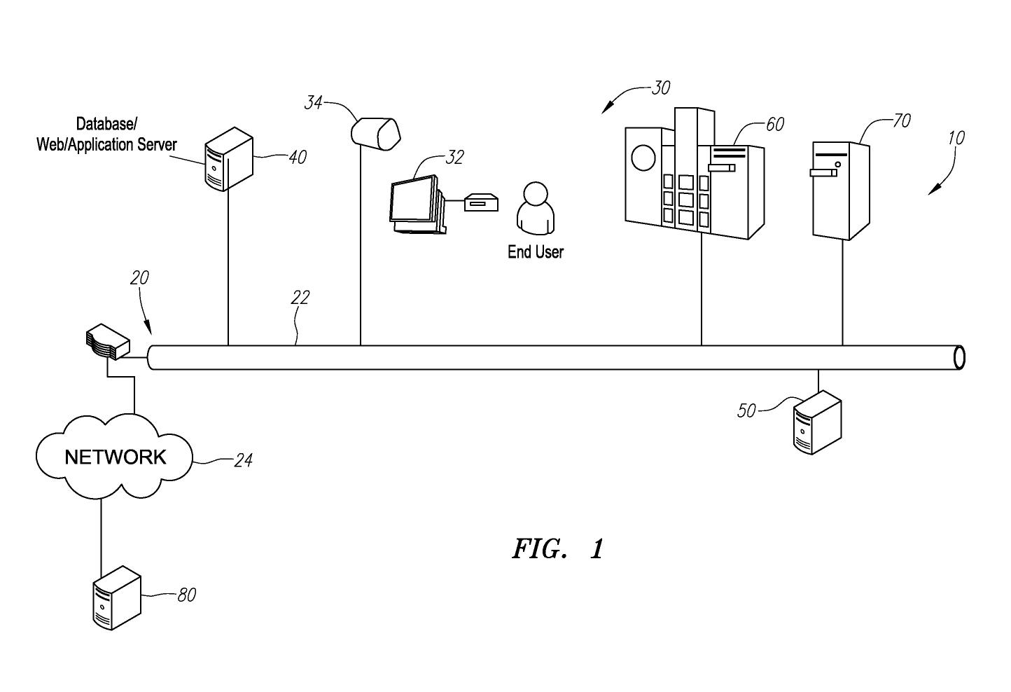

An embodiment of the current invention is now further described with reference to FIG. 1 which depicts an integrated system, such as a CBMS 10, for conducting financial transactions, preferably in a secure and automated manner. As shown, CBMS 10 involves a variety of devices that may be integrated over network 20. Network 20 may itself include network 22 which may comprise a LAN and/or the internet to which various devices may be remotely accessed over the web. Network 22 may also generally include cyber space cloud 24 in order to remotely access other devices. As such, an advantage of the current invention is the integration of the devices described below through a web-based system. In a preferred embodiment, Microsoft Windows is used for the web-based system. Another advantage of the current invention is the software that provides for the integration of the various devices.

As shown in FIG. 1, CBMS 10 may include login device 30. The user may interact with login device to obtain access to CBMS 10. Login device 30 may include touch screen 32 on which the user may enter a user ID and a PIN or other type of password. The user may also enter a user ID and then swipe a key card.

Alternatively, login device 30 may include an iris biometrics security reader 34. This embodiment provides several advantages that provide greater security and convenience. For example, iris reader 34 preferably avoids the need for a user to have a PIN or other password that could be compromised by another person standing over the employee's shoulder while the employee enters the password. This also preferably avoids the situation where the employee provides his or her password to another employee.

Iris reader 34 also preferably provides greater convenience in that, for example, the situation where an employee forgets his or her password is avoided. This in turn avoids wasting the employee's time as well as other employees who may be waiting to use system 10 while the employee tries to remember his or her password.

Iris reader 34 also preferably allows the user to be authorized more quickly as iris reader 34 may quickly obtain the user's iris information by the user simply looking at the reader 34. Upon iris reader 34 obtaining the user's iris information, iris reader 34 may transmit a signal over network 20 to a database containing the iris information of authorized users of that employer. A comparison function may then occur to determine whether the user whose iris has just been scanned matches with that of any authorized user in the database. If so, a signal may be transmitted over network 20 to login device 30 indicating that the user is authorized to perform financial transactions.

Iris reader 34 preferably saves the time of an employee undertaking the task of entering a user ID and/or password on a touch screen. A preferred iris reader is the Eyeswipe Nano manufactured by Hoyos.

Preferably, when an employee becomes employed by the company, such as a casino, hotel or other establishment, the employee intake process performed by the human resources or other department, may include the employee's iris being scanned so that the appropriate information may be input into an employee iris database. This database may reside at any suitable location and is preferably accessed over the web via network 20.

In this manner, a biometric ID is preferably established for each employee. This may in turn reduce or avoid the need for employee ID cards, passwords, etc. which preferably provides the security and convenience benefits mentioned above.

System 10 may also include application server and/or database 40 that may be connected to network 20 and that may be remotely accessed over the web. Server 40 may include various types of information associated with each employee, e.g., the level or type of access a particular employee is granted upon being authorized by login device 30. Server 40 may also include software which integrates the various devices remotely accessed over network 20 as discussed below. For example, server 40 may include the software used to compare the iris information obtained by scanner 34 to that with the iris database.

The software application of the current invention may reside on server 40. As noted above, this software preferably provides integration protocols for current and future methodologies to provide for various financial transactions and to allow the usage of data accumulated and stored by system 10 for accounting and other types of reports.

Another device accessible over the web or otherwise networked into system 10 may be server 50 that stores and associates financial transactions with a particular employee during that employee's shift. For example, server 50 may communicate with POS device(s) that had been accessed by an employee during his or her shift to determine the number and amounts of credit card transactions that that employee performed. In a preferred embodiment, server 50 may comprise a Micros 9700 server.

In this embodiment, when the employee ends his or her shift, server 50 may obtain information from the POS device(s) and then send a signal over network 20 reflecting a summary of that employee's transactions during the shift. This signal may be sent to server 40 which may then use this information to determine, for example, the amount of “due back” or cash a particular employee should receive from a cash/non-cash delivery device. In this manner, server 40 operates to integrate server 50 and the delivery system discussed below.

Other devices that may be remotely access over the web include the following. Employee banking device 60 may be integrated into system 10. Upon the user successfully logging in to system 10, banking device may perform such functions as bank/till disbursement, verified deposit, even cash exchange, due back disbursement and petty cash disbursement. As noted above, server 50 may calculate any due back owed to the employee, and banking device 60 may make that disbursement. Examples of employee banking devices are the Tidel Sentinel BCDR 60 and the Tidel Sentinel SCD 70. Other devices such as The Revolution™ provided by AGT Worldwide may also be used.

Preferably, server 40 integrates server 50 and banking device 60 to complete the employee banking transaction once server 40 has confirmed that the user's iris information read by scanner 34 matches with the user's information in the iris database. In this manner, server 40 provides an integration function. Server 40 preferably also contains software to provide user interfaces as needed for any of the devices connected to system 10 via network 20.

System 10 may also include a server 80 that may provide accounting reports. In this embodiment, server 80 may be connected to network 20 and/or information stored through/in cloud 24. Preferably, server 40 may export information regarding financial transactions that have occurred with system 10, and server 80 may use this information to provide accounting reports. A preferred accounting server is the Evention Host Server.

The current invention has additional applications beyond those described above. For example, an iris recognition reader such as the Hoyos HBOX or EyeSwipe may be used as employees enter or exit the company's property. The HBOX is an archway iris recognition device under which all employees may walk and have their irises read. In this manner, the company may keep track of when its employees are on or off the property which in turn may help with security, premises liability and other issues. This data could then be saved in server 40 and used in various ways to help provide overall information and reporting functions to the employer.

Another application of the current invention could involve, for example, providing hotel guests with access to their rooms. That is, upon registering at the hotel's front desk, the guest could look into an iris reader to establish a biometric ID particular to that guest. In this embodiment, a database of iris information for the hotel's guests may be maintained and connected to network 20. Each guest room may also have an iris reader mounted on or near its door. To enter the room, the guest may look into the iris reader mounted on or near the door, and the information obtained thereby could be used to determine whether the iris information matches information in the guest iris database so that the guest is granted access to that room.

In this embodiment, network 20 may again be integrated by server 40 on which software may reside to perform the various functions associated with granting room access to the guest. For example, server 40 may perform the function of comparing the information read by an iris reader and information in the guest iris database. Server 40 may also then send a signal to the door to unlock it. An advantage of this embodiment is the potential avoidance of room keys which may be lost or stolen, which in turn provides convenience and security benefits.

In another application of the current invention, system 10 may provide information about credits that an employee may have accumulated over time. For example, at an employee's shift's end, the employee may have his or her iris read, and system 10 may then calculate credit information based on information from server 50. Integration server 40 may then advise system 10 of the amount of credit. This credit information may then be provided over network 20 to, for example, a store located on the property. In this embodiment, system 10 would then allow the employee to purchase items at that property store without the need for cash or a credit card. This embodiment would have particular usefulness at gaming establishments where a number of stores are typically located on property.

Another application of system 10 would involve the use of a smart phone camera such that a user or a hotel guest could take a picture of his or her iris, which picture information could then be sent over system 10 to server 40, which could then use this information to, for example, unlock the guest's hotel door. This would provide the benefit of having iris scanners on or near each guest room door.

Other applications for system 10 involve prisons and correctional institutions. For example, upon each inmate being admitted, their iris information could be stored into an inmate iris database. The iris of any departing inmate could then be scanned and matched with the database to ensure that the correct inmate is being released. The inmate iris database could also be used, for example, where an inmate purchases something from any store located at the prison. That is, before any purchase, the inmate's iris may be scanned and matched with the appropriate inmate in the database and thereby deduct any credit that the inmate may have.

Another application of the current invention involves the increased number of locations where various types of gaming is becoming available. For example, an increasing number of states are allowing gaming in bars, restaurants and other locations. In these situations, system 10 may provide accounting features to track the gaming transactions that have occurred and results thereof. Integrated system 10 may then provide information to pertinent governmental agencies for tax purposes or other uses.

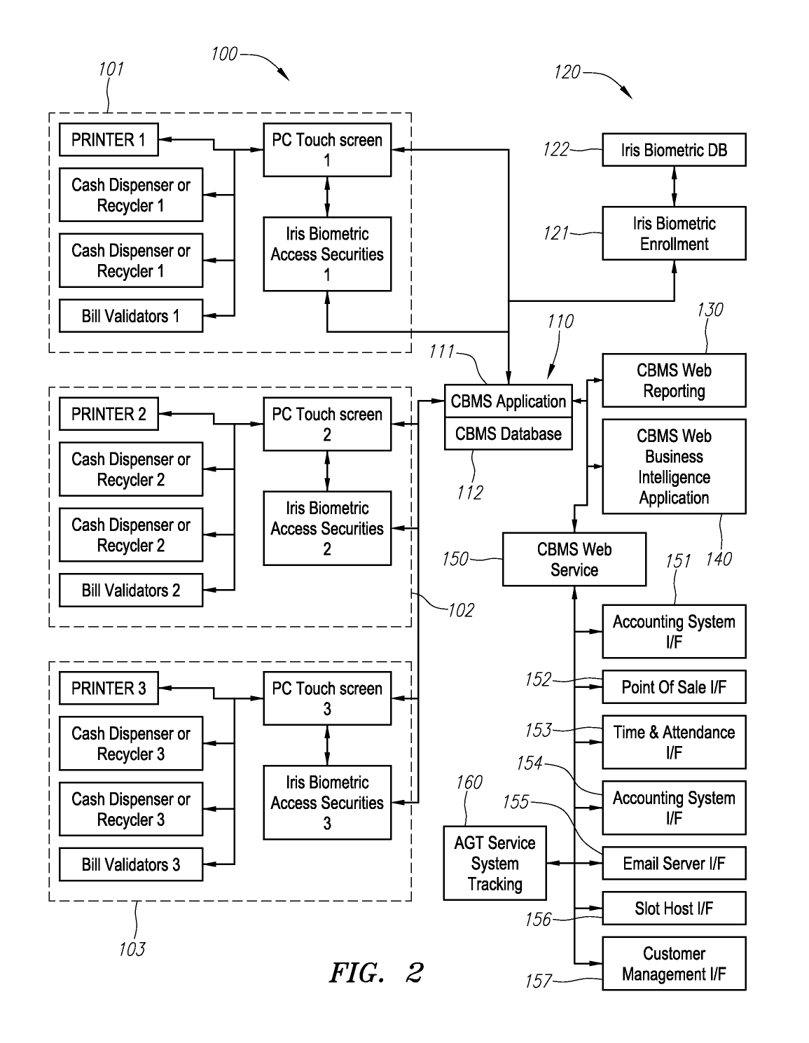

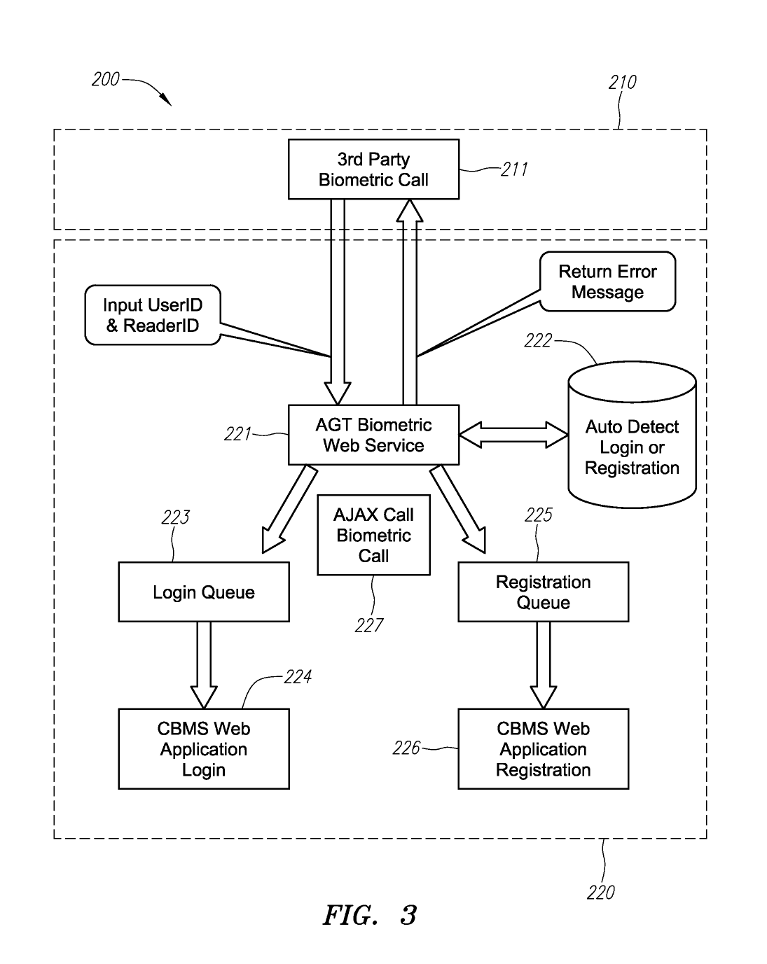

System 100, which may be another embodiment of system 10, is now further described with reference to FIGS. 2 and 3. As shown in FIG. 2, system 100 may include subsystems 101, 102, 103, which may each in turn include login devices such as login devices such as PC touch screens and iris biometric access securities. Each subsystem 110, may also include a bill validator, cash dispenser or recycler and printer.

Through FIG. 2 shows three subsystems 101, 102, 103, system 100 may include additional and different types of subsystems. As shown, the components comprising each subsystem may communicate with each other to provide the desired functions.

It is preferred that subsystems 101, 102, 103 be connected to integration server 110 or other device that may integrate the functions of system 100. As shown, server 110 may include CBMS application 111 and CBMS database 112. As noted above, server 110 may contain software to integrate the various subsystems as well as other devices networked into system 100.

For example, system 100 may include iris biometric device(s) 120 that provide security measures. As shown, biometric device(s) 120 may include iris biometric database 122 in which iris information for a particular universe of individuals, e.g., employees, hotel guests, etc., may be stored. Database 122 may be populated through an enrollment 121 device. For example, an employee's first day on the job may involve the creation of an iris biometric ID which is then stored in database 122.

As shown, integration server 110 may compare iris information of a particular employee from subsystem 101 and compare it to iris information stored in database 122 to determine if there is a match in order to provide access to the employee. As shown, iris device 120 may be located remotely from any of the subsystems 101, 102, 103, and it is preferred that they may be accessed over the web. Integration server 110 preferably uses protocols to provide such access.

System 100 may also include CBMS web reporting 130 and CBMS web business intelligence application 140. As shown, these devices and functions may also be remotely located and accessed over the network such as the web. Preferably, integration server 110 may use information from other devices connected to the network, for example, from any of subsystems 101, 102, 103, and may run reporting or other business intelligence applications thereon to provide useful reports.

System 100 may also include CBMS web services 150, which may in turn include accounting system interface 151, point of sale interface 152, time and attendance interface 153, accounting system 154, e-mail server interface 155, slot host interface 156, customer management interface 157. Integration server 110 preferably integrates these interfaces with system 100. System 100 may also include service system tracking device 160. As such information provided by these interfaces and/or tracking system 160 may be used with, for example, business intelligence applications 140 to provide useful overall information and/or reports to the employer about its employees, the hotel about its guests, the prison about its inmates, etc.

Reference is now made to FIG. 3 which describes system 200 pertaining to, for example, the log in process involving biometric information. As shown, system 200 may include subsystems 210, 220. Subsystem 210 may include third party biometric call 211 that may interface with biometric web service 221 of subsystem 220. As shown, a user ID and reader ID may be input by third party biometric call 211 to biometric web service 221. If appropriate, an error message may be returned.

Alternatively, biometric web service 221 may interface with auto detect login or registration 222. Alternatively, biometric web service 221 may interface with login queue 223 and web application login 224, or registration queue 225 and web application registration 226. A biometric call 227 may also be involved.

While various embodiments of systems for providing secure financial transactions have been presented in the foregoing disclosure, numerous modifications, alterations and alternate embodiments may be contemplated by those skilled in the art and may be utilized in accomplishing the various aspects of the present invention. Thus, it is to be clearly understood that this description is made only by way of example and not as a limitation on the scope of the invention.

What is claimed is:

1. An integrated system for secure financial transactions, comprising:
a network;
an integration server;
a login device that authorizes users of the system and that is connected to the network;
a banking device that performed financial transactions and that is connected to the network; and
a server that accesses prior financial transactions and provides information about such prior financial transactions to the integration server.

2. The integrated system of claim 1, wherein the login device is an iris biometrics reader.

3. The integrated system of claim 2, further comprising an authorized user iris database, and wherein the integration server receives a user's iris information from the login device and compares this information with information contained in the authorized user iris database.

4. The integrated system of claim 3, wherein the banking device performs a financial transaction based on a level of access provided by the integration server based on the iris information.

5. The integrated system of claim 1, further comprising an accounting server, wherein the integration server exports data to the accounting server which then provides accounting reports.
